(19) United States
(12) Patent Application Publication
(10) Pub. No.: US 2015/0346418 A1
(43) Pub. Date: Dec. 3, 2015

(54) BACKLIGHT MODULE AND LCD USING THE SAME

(71) Applicant: Shenzhen China Star Optoelectronics Technology Co., Ltd., Shenzhen, Guangdong (CN)

(72) Inventors: Shihhsiang Chen, Shenzhen (CN); Yuchun Hsiao, Shenzhen (CN); Chengwen Que, Shenzhen (CN)

(73) Assignee: Shenzhen China Star Optoelectronics Technology Co., Ltd., Shenzhen, Guangdong (CN)

(21) Appl. No.: 14/368,794

(22) PCT Filed: Jun. 3, 2014
(86) PCT No.: PCT/CN2014/079067

§ 371 Date: Jun. 25, 2014

(30) Foreign Application Priority Data
May 29, 2014 (CN) 201410234554.8

(51) Int. Cl. F21V 8/00; G02F 1/1335

(52) U.S. Cl. CPC G02B 6/0051; G02F 1/133528

(57) ABSTRACT

A backlight module includes a back plate, a reflection sheet disposed on the back plate, a light guide plate disposed on the reflection sheet, an optical resin layer disposed on the light guide plate, and a backlight source disposed at a surface of the light guide plate. The optical resin layer provides with a diffusion structure such that lights which are emitted into the optical resin layer emits out after forming an even surface light source. After lights which are emitted from the backlight source emit into the light guide plate, the lights emits out from the optical resin layer. The backlight module does not use an optical film module so as to reduce the product cost. The present invention also discloses a liquid crystal display using the above illustrated backlight module.

### BACKGROUND OF THE INVENTION

1. Field of the Invention

The present invention relates to a liquid crystal display technology, and more particularly to a backlight module and a liquid crystal display using the backlight module.

2. Description of Related Art

A liquid crystal display (LCD) is a thin-flat display device, which consists of a number of color or monochrome pixels. The LCD is placed in front of a light source or a reflection plate. The power consumption of the LCD is very low, and the LCD has features of high-quality, small size, light weight such that everyone love the LCD. As a result, the LCD becomes a mainstream display.

The LCD includes a liquid crystal display (LCD) panel and a backlight module. The LCD panel and the backlight module are disposed oppositely. The backlight module provides a light source to the LCD panel such that the LCD panel can display an image. The LCD panel is formed by two transparent substrates and liquid crystals sealed between the transparent substrates. Currently, the LCD mainly uses a thin-film -transistor (TFT) LCD panel. The backlight module mainly divides into a direct-light type and a side-light type. FIG. 1 illustrates a schematic diagram of a backlight module and an LCD according to the prior art. As shown in FIG. 1, the backlight module mainly comprises a back plate, a reflection sheet, a light guide plate, and an optical film module, stacked sequentially. A backlight source is disposed at a side surface of the light guide plate. The backlight source emits lights, and the lights change directions or become uniform through the light guide plate and the optical film module. The lights emit out from a top surface of the optical film module and provide to the LCD panel.

As shown in FIG. 1, because the backlight module uses the optical film module with a larger area, and the optical film module includes a diffusion film, a prism film and an antireflection film, the cost of the optical film module is expensive. Besides, the films are easily to be damaged, and deform by expansion and shrinkage. Therefore, the LCD cannot display well.

### SUMMARY OF THE INVENTION

To solve the above problems of the prior art, the present invention provides a backlight module, and the backlight module does not use an optical film module, reducing the cost of the product.

To achieve the above purpose, the present invention adopts the following technical solutions: a backlight module, comprising:

a back plate;

a reflection sheet disposed on the back plate;

a light guide plate disposed on the reflection sheet;

an optical resin layer disposed on the light guide plate, wherein, the optical resin layer provides with a diffusion structure such that lights which are emitted into the optical resin layer emits out after forming an even surface light source; and

a backlight source disposed at a side surface of the light guide plate, wherein, after lights which are emitted from the backlight source emit into the light guide plate, the lights emits out from the optical resin layer.

Wherein, the optical resin layer is made of acrylics resin or silicone resin.

Wherein, the diffusion structure is formed by disposing transparent fine particles into the optical resin layer.

Wherein, the transparent fine particles are acrylic diffusion particles.

Wherein, the diffusion structure is formed by fabricating transparent fine particles on the optical resin layer through a coating process or an imprint process.

Wherein, the transparent fine particles are acrylic diffusion particles.

Wherein, the diffusion structure is formed by injecting a gas to form a foamed structure in the fabrication process of the optical resin layer.

Wherein, the optical resin layer is made of a transparent and foamed material such that the optical resin layer includes a foamed structure to form the diffusion structure.

Wherein, an adhesion layer is disposed on the optical resin layer.

The present invention also provides a liquid crystal display (LCD) comprising: a liquid crystal display panel including a first polarizing film, a thin-film-transistor (TFT) glass substrate, a liquid crystal layer, a color filter (CF) glass substrate, and a second polarizing film, stacked sequentially; and a backlight module as illustrated above; wherein, the optical resin layer faces toward the first polarizer film, and adheres to the liquid crystal display panel.

Beneficial Effects:

The backlight module and the LCD provided by the present invention do not use the optical film module so as to reduce the product cost, improve the utilization rate of the light source, and increase the product quality. Besides, the backlight module can directly adhere to the LCD panel so as to reduce the thickness of the entire LCD.

### BRIEF DESCRIPTION OF THE DRAWINGS

FIG. 1 is a schematic diagram of a backlight module and an LCD according to the prior art.

FIG. 2 is a schematic diagram of a backlight module and an LCD according to an embodiment of the present invention.

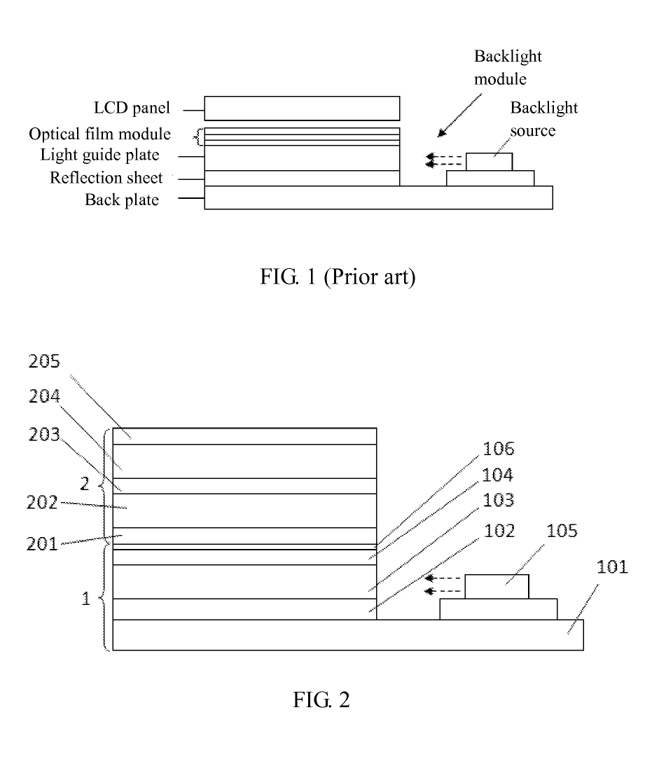

### DETAILED DESCRIPTION OF THE PREFERRED EMBODIMENT

As described above, the present invention improves the drawback of the prior art, and provides an optical module, comprising: a back plate; a reflection sheet disposed on the back plate; a light guide plate disposed on the reflection sheet; an optical resin layer disposed on the light guide plate, wherein, the optical resin layer provides with a diffusion structure such that lights emitted into the optical resin layer emits out after forming an even surface light source; and a backlight source disposed at a side surface of the light guide plate, wherein, lights emitted from the backlight source emits out from the optical resin layer after emitting into the light guide plate.

The present invention also provides an LCD comprising the above illustrated backlight module. The LCD includes a liquid crystal display (LCD) panel and a backlight module. Wherein the LCD panel comprises a first polarizing film, a thin-film- transistor (TFT) glass substrate, a liquid crystal layer, a color filter (CF) glass substrate, and a second polarizing film, stacked sequentially. Wherein, the backlight module is illustrated above. Besides, the optical resin layer faces toward the first polarizer film, and adhered to the LCD panel.

The backlight module and the LCD described above do not use the optical film module so as to reduce the product cost, improve the utilization rate of the light source, and increase the product quality. Besides, the backlight module can directly adhere to the LCD panel so as to reduce the thickness of the entire LCD.

FIG. 2 is a schematic diagram of a backlight module and an LCD according to an embodiment of the present invention. As shown in FIG. 2, the liquid crystal display (LCD) includes a liquid crystal display (LCD) panel 2 and a backlight module 1. The LCD panel 2 comprises a first polarizing film 201, a thin-film-transistor (TFT) glass substrate 202, a liquid crystal layer 203, a color filter (CF) glass substrate 204, and a second polarizing film 205, stacked sequentially. The backlight module 1 comprises a back plate 101, a reflection sheet 102 disposed on the back plate 101, a light guide plate 103 disposed on the reflection sheet 102, an optical resin layer 104 disposed on the light guide plate 103, and a backlight source 105 disposed at a side surface of the light guide plate 103. Wherein, an adhesion layer 106 is disposed on the optical resin layer 104. The backlight module 1 directly adheres to the LCD panel 2 through the adhesion layer 106. The optical resin layer 104 provides with a diffusion structure such that lights which are emitted into the optical resin layer 104 emits out after forming an even surface light source. After lights which are emitted from the backlight source 105 emit into the light guide plate 103, the lights emits out from the optical resin layer 104 to the LCD panel 2.

Wherein, the optical resin layer 104 is made of acrylic resin or silicone resin.

Wherein the diffusion structure in the optical resin layer 104 can be obtained by: (1) Disposing transparent fine particles into the optical resin layer 104 to form the diffusion structure; (2) Fabricating transparent fine particles on the optical resin layer 104 through a coating process or an imprint process to form the diffusion structure; (3) In the fabrication process of the optical resin layer 104, injecting a gas to form a foamed structure to form the diffusion structure; (4) Utilizing a transparent and foamed material as the material for fabricating the optical resin layer 104 such that after fabricating the optical resin layer 104, the optical resin layer 104 includes a foamed structure to form the diffusion structure. Wherein, the aforementioned fine particles are preferably acrylic diffusion particles, that is, made of acrylic resin.

In summary, the present invention provides a backlight module and a liquid crystal display. The backlight module and the LCD do not use the optical film module so as to reduce the product cost, improve the utilization rate of the light source, and increase the product quality. Besides, the backlight module can directly adhere to the LCD panel so as to reduce the thickness of the entire LCD.

It should be noted that, herein, relational terms such as first and second, and the like are only used to distinguish one entity or operation from another entity or operation. It is not required or implied that these entities or operations exist any such relationship or order between them. Moreover, the terms “comprise,” include,” or any other variation thereof, are intended to cover a non-exclusive inclusion, such that a series of elements including the process, method, article or device that includes not only those elements but also other elements not expressly listed or further comprising such process, method, article or device inherent elements. Without more constraints, by the statement “comprises one . . . ” element defined does not exclude the existence of additional identical elements in the process, method, article, or apparatus.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A backlight module, comprising:
a back plate;
a reflection sheet disposed on the back plate;
a light guide plate disposed on the reflection sheet;
an optical resin layer disposed on the light guide plate, wherein, the optical resin layer provides with a diffusion structure such that lights which are emitted into the optical resin layer emits out after forming an even surface light source; and
a backlight source disposed at a side surface of the light guide plate, wherein, after lights which are emitted from the backlight source emit into the light guide plate, the lights emits out from the optical resin layer.

2. The backlight module according to claim 1, wherein, the optical resin layer is made of acrylics resin or silicone resin.

3. The backlight module according to claim 2, wherein, the diffusion structure is formed by disposing transparent fine particles into the optical resin layer.

4. The backlight module according to claim 3, wherein, the transparent fine particles are acrylic diffusion particles.

5. The backlight module according to claim 2, wherein, the diffusion structure is formed by fabricating transparent fine particles on the optical resin layer through a coating process or an imprint process.

6. The backlight module according to claim 5, wherein, the transparent fine particles are acrylic diffusion particles.

7. The backlight module according to claim 2, wherein, the diffusion structure is formed by injecting a gas to form a foamed structure in the fabrication process of the optical resin layer.

8. The backlight module according to claim 1, wherein, the optical resin layer is made of a transparent and foamed material such that the optical resin layer includes a foamed structure to form the diffusion structure.

9. The backlight module according to claim 1, wherein, an adhesion layer is disposed on the optical resin layer.

10. The backlight module according to claim 2, wherein, an adhesion layer is disposed on the optical resin layer.

11. A liquid crystal display (LCD), comprising:
a liquid crystal display panel including a first polarizing film, a thin-film-transistor (TFT) glass substrate, a liquid crystal layer, a color filter (CF) glass substrate, and a second polarizing film, stacked sequentially; and
a backlight module having:
a back plate;
a reflection sheet disposed on the back plate;
a light guide plate disposed on the reflection sheet;
an optical resin layer disposed on the light guide plate, wherein, the optical resin layer provides with a diffusion structure such that lights which are emitted into the optical resin layer emits out after forming an even surface light source; and
a backlight source disposed at a side surface of the light guide plate, wherein, after lights which are emitted from the backlight source emit into the light guide plate, the lights emits out from the optical resin layer;
wherein, the optical resin layer faces toward the first polarizer film, and adheres to the liquid crystal display panel.

12. The liquid crystal display according to claim 11, wherein, the optical resin layer is made of acrylics resin or silicone resin.

13. The liquid crystal display according to claim 12, wherein, the diffusion structure is formed by disposing transparent fine particles into the optical resin layer.

14. The liquid crystal display according to claim 13, wherein, the transparent fine particles are acrylic diffusion particles.

15. The liquid crystal display according to claim 12, wherein, the diffusion structure is formed by fabricating transparent fine particles on the optical resin layer through a coating process or an imprint process.

16. The liquid crystal display according to claim 15, wherein, the transparent fine particles are acrylic diffusion particles.

17. The liquid crystal display according to claim 12, wherein, the diffusion structure is formed by injecting a gas to form a foamed structure in the fabrication process of the optical resin layer.

18. The liquid crystal display according to claim 11, wherein, the optical resin layer is made of a transparent and foamed material such that the optical resin layer includes a foamed structure to form the diffusion structure.

19. The liquid crystal display according to claim 11, wherein, an adhesion layer is disposed on the optical resin layer.

20. The liquid crystal display according to claim 12, wherein, an adhesion layer is disposed on the optical resin layer.
